(19) United States
(12) Patent Application Publication
(10) Pub. No.: US 2023/0179781 A1
(43) Pub. Date: Jun. 8, 2023

(54) SYSTEMS AND METHODS FOR STORING AND TRANSMITTING VIDEO DATA

(71) Applicant: Meta Platforms, Inc., Menlo Park, CA (US)

(72) Inventor: Colleen Kelly Henry, Oakland, CA (US)

(21) Appl. No.: 17/542,318

(22) Filed: Dec. 3, 2021

(51) Int. Cl. H04N 19/34; H04N 21/2343; H04N 19/59; H04N 19/70

(52) U.S. Cl. CPC H04N 19/34; H04N 19/59; H04N 19/70; H04N 21/23439

(57) ABSTRACT

A computer-implemented method for storing and transmitting video files may include (i) encoding a video file at a group of different resolutions by (a) generating a group of base layers for the video file, each at a different resolution within the different resolutions and (b) generating an enhancement layer for the video file that, when combined with any base layer for the video file, increases the effective resolution of a resulting combined video file over a resolution of the base layer, (ii) receiving a request for the video file at a specified resolution, and (iii) providing the video file at the specified resolution by, in response to receiving the request, selecting an appropriate base layer from the base layers to combine with the enhancement layer to achieve the specified resolution. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIGS. 1A and 1B are illustrations of exemplary systems for storing and transmitting video data.

FIG. 2 is a block diagram of an exemplary system for storing and transmitting video data.

FIG. 3 is a flow diagram of an exemplary method for storing and transmitting video data.

FIG. 4 is an illustration of exemplary video data.

FIG. 5 is an illustration of an exemplary system for transmitting video data via multicasting.

FIGS. 6A and 6B are illustrations of exemplary systems for storing and transmitting video data.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

One efficient way of transmitting video data is to separate out the data into a base layer, which can be compressed via one set of compression techniques, and to also create an enhancement layer, which can be compressed using a different set of compression techniques. At the time of playback, the base and the enhancement layer may be combined to reconstitute the final video. This approach can be used to enhance compression and/or add quality in ways that are beyond what one of those sets of compression techniques may achieve alone. Often, the enhancement layer compresses sharper or finer details, while a lower resolution base layer is used. In some embodiments, an enhancement layer applied on top of a base layer can increase the effective quality and/or resolution of the final file over the resolution produced by the base layer alone. Some systems for storing and transmitting video files may package each of many different base layers (e.g., of different resolutions and/or codecs) with the enhancement layer and store and serve the combined files, meaning that many copies of the enhancement layer are stored and clients that request more than one base layer receive multiple copies of the enhancement layer.

By separating out the enhancement layer and serving the enhancement layer separately from each base layer, the systems described herein may conserve resources while increasing the flexibility of the types of files and streams available. For example, when adaptive bitrate video is needed, the systems described herein may provide a client with a base layer, with an optional and additional enhancement layer should there be enough bandwidth available. If the connection slows, the systems described herein may enable the client to suspend the downloading of the enhancement layer until such time as the connection speeds increase again. Additionally, if the application of the enhancement layer uses additional or different resources than the base layer, such as graphics processing unit (GPU) or central processing unit (CPU) resources as opposed to application-specific integrated circuit (ASIC) hardware video decoders, a client device may decode only the base layer, saving system resources such as battery life and/or taking advantage of hardware acceleration. In this example, if the client device becomes plugged in and battery life is no longer a concern, the client device may begin downloading and applying the enhancement layer. In some embodiments, the systems described herein may offer a new, resource-intensive codec as the base codec of a video, such as AOMedia Video 1 (AV1). In some examples, the costs of encoding this codec in software may be too high to go beyond certain resolutions (e.g., beyond 720p) and/or the decode cost when using a software decoder on a client device may become too high beyond certain resolutions. In these examples, the systems described herein may provide an enhancement layer to achieve the desired resolutions with less strain on computing resources, enabling the system to offer higher-resolution versions of the new codec without dedicating the resources to produce the highest-resolution base layers.

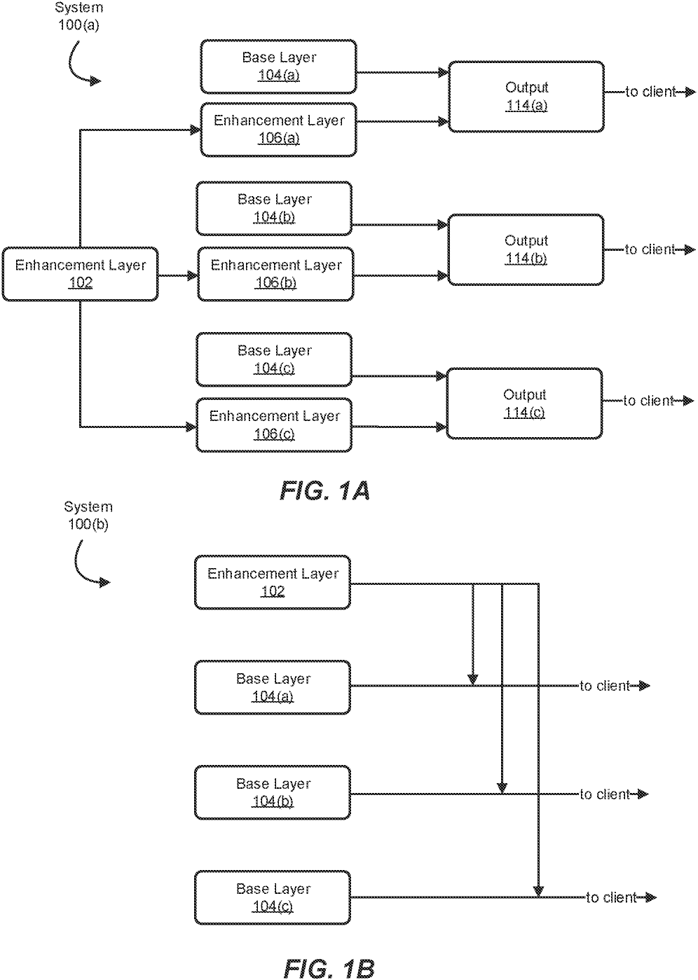

In some embodiments, the systems described herein may improve the functioning of a computing device by conserving computing resources dedicated to storing and/or transmitting video files. Additionally, the systems described herein may improve the fields of media storage and/or streaming video by improving the efficiency at which video files may be stored and/or transmitted. For example, as illustrated in FIG. 1A, a system 100(a) for storing and transmitting video files may store multiple different base layers, such as base layers 104(a), 104(b), and/or 104(c) and may combine each base layer with different instances of an enhancement layer 102, such as enhancement layers 106(a), 106(b), and/or 106(c) to produce outputs 114(a), 114(b), and/or 114(c), respectively. In one example, system 100(a) may transmit output 114(a) to a client, which may decompress base layer 104(a) and combine the decompressed base layer 104(a) with enhancement layer 106(a) to obtain a playable video file. Because outputs 114(a), 114(b), and/or 114(c) each contain a separate copy of enhancement layer 102, system 100(a) may consume memory storing redundant copies of enhancement layer 102. By contrast, system 100(b) illustrated in FIG. 1B may store a single copy of enhancement layer 102 that is not pre-emptively combined with any of base layers 104(a), 104(b), and/or 104(c). In one example, system 100(b) may transmit enhancement layer 102 and either base layer 104(a), 104(b), or 104(c) to the client. Because system 100(b) stores and serves enhancement layer 102 separately from each base layer, system 100(b) may not consume excess memory storing redundant copies of enhancement layer 102.

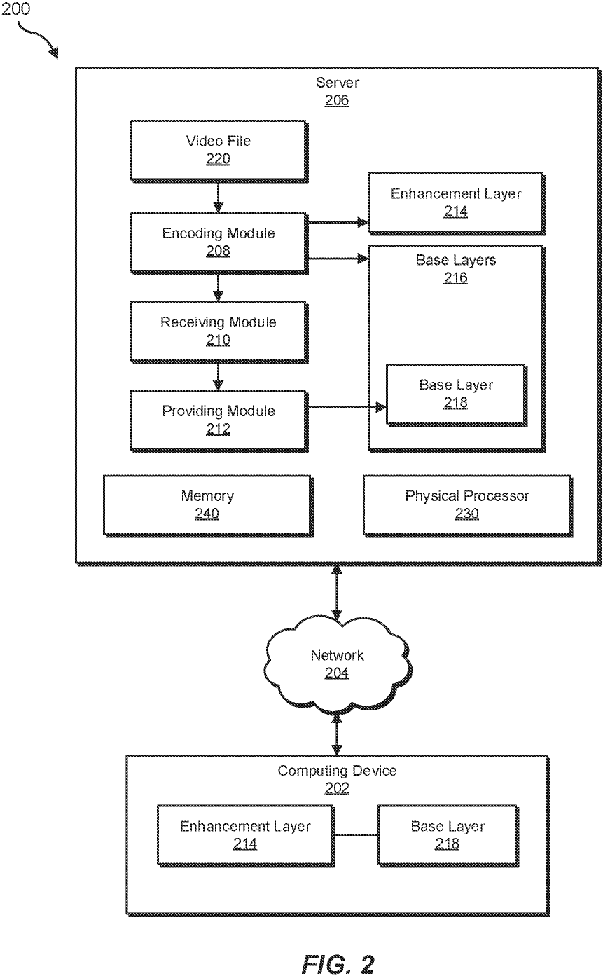

In some embodiments, the systems described herein may generate and/or transmit video files via a media server. FIG. 2 is a block diagram of an exemplary system 200 for storing and transmitting media files. In one embodiment, and as will be described in greater detail below, a server 206 may be configured with an encoding module 208 that may encode a video file 220 at a plurality of different resolutions by generating base layers 216 for video file 220, each at a different resolution within the plurality of different resolutions and generating an enhancement layer 214 for video file 220 that, when combined with any base layer 218 for video file 220, increases the effective resolution of a resulting combined video file over a resolution of base layer 218. At some later point in time, a receiving module 210 may receive a request for video file 220 at a specified resolution (e.g., from a computing device 202 via a network 204). In response, providing module 212 may provide video file 220 at the specified resolution by selecting an appropriate base layer 218 from base layers 216 to combine with enhancement layer 214 to achieve the specified resolution.

Server 206 generally represents any type or form of backend computing device that may generate, store, and/or transmit video files. Examples of server 206 may include, without limitation, media servers, application servers, database servers, and/or any other relevant type of server. Although illustrated as a single entity in FIG. 2, server 206 may include and/or represent a group of multiple servers that operate in conjunction with one another.

Computing device 202 generally represents any type or form of computing device capable of reading computer-executable instructions. For example, computing device 202 may represent a personal computing device. Additional examples of computing device 202 may include, without limitation, a laptop, a desktop, a tablet, a phone, a wearable device, a smart device, an artificial reality device, a personal digital assistant (PDA), etc.

As illustrated in FIG. 2, example system 200 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of the modules illustrated in FIG. 2. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 2, example system 200 may also include one or more physical processors, such as physical processor 230. Physical processor 230 generally represents any type or form of hardware-implemented processing unit capable of interpreting and/or executing computer-readable instructions. In one example, physical processor 230 may access and/or modify one or more of the modules stored in memory 240. Additionally or alternatively, physical processor 230 may execute one or more of the modules. Examples of physical processor 230 include, without limitation, microprocessors, microcontrollers, CPUs, Field-Programmable Gate Arrays (FPGAs) that implement softcore processors, Application-Specific Integrated Circuits (ASICs), portions of one or more of the same, variations or combinations of one or more of the same, and/or any other suitable physical processor.

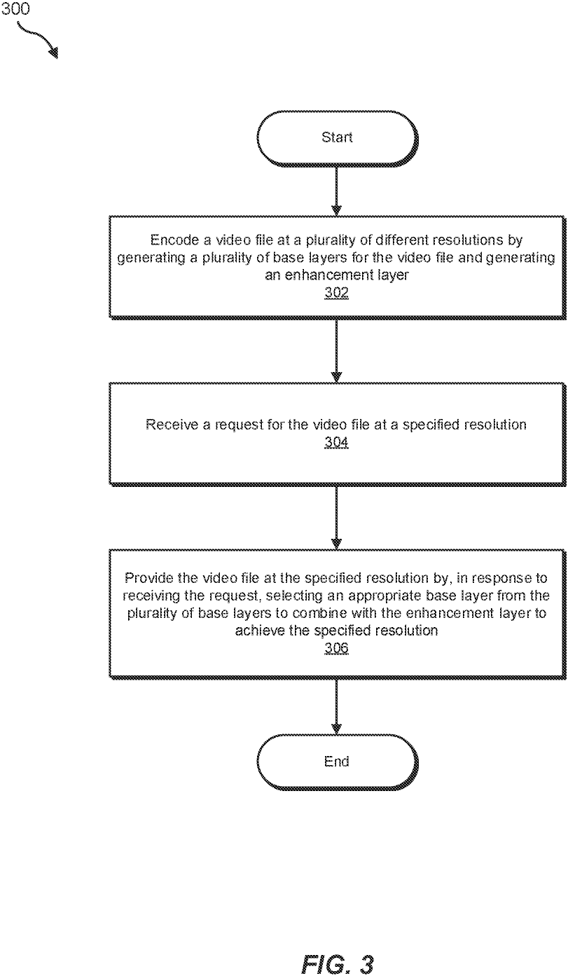

FIG. 3 is a flow diagram of an exemplary method 300 for storing and transmitting video files. As illustrated in FIG. 3, at step 302, one or more of the systems described herein may encode a video file at a plurality of different resolutions by generating a plurality of base layers for the video file and generating an enhancement layer. For example, encoding module 208 may, as part of server 206 in FIG. 2, encode video file 220 at a plurality of different resolutions by generating a base layers 216 for video file 220 and generating enhancement layer 214.

The term “video file” may generally refer to any digital representation of a video. In some embodiments, a video file may be composed of a series of image frames and/or one or more audio tracks. In one embodiment, a video file may be in an uncompressed and/or unencoded state before being encoded by the encoder of a video codec, stored on a media server, transmitted by a client device, and then decoded by a decoder of a video codec on the client device. In some embodiments, a media system may generate and/or store multiple versions of a video file that are encoded at different resolutions and/or by different encoders.

The term “base layer” may generally refer to a compressed and/or encoded (e.g., via a compression algorithm and/or codec) version of a video file that is capable of being decoded by a video decoder and then played in a video player. In some embodiments, a base layer may have a lower resolution than an original, uncompressed and/or unencoded version of the video file. In some examples, a base layer, when decoded and played, may lack fine visual details that were present in the original version of the video file. The term “enhancement layer” may generally refer to a file that stores fine visual details that are not expected to be found in a base layer. Unlike a base layer, an enhancement layer may not be capable of being independently decoded and then played in a video player. In some embodiments, a base layer may be designed to be decodable by a hardware decoder while an enhancement layer may be designed to be decodable by a software decoder.

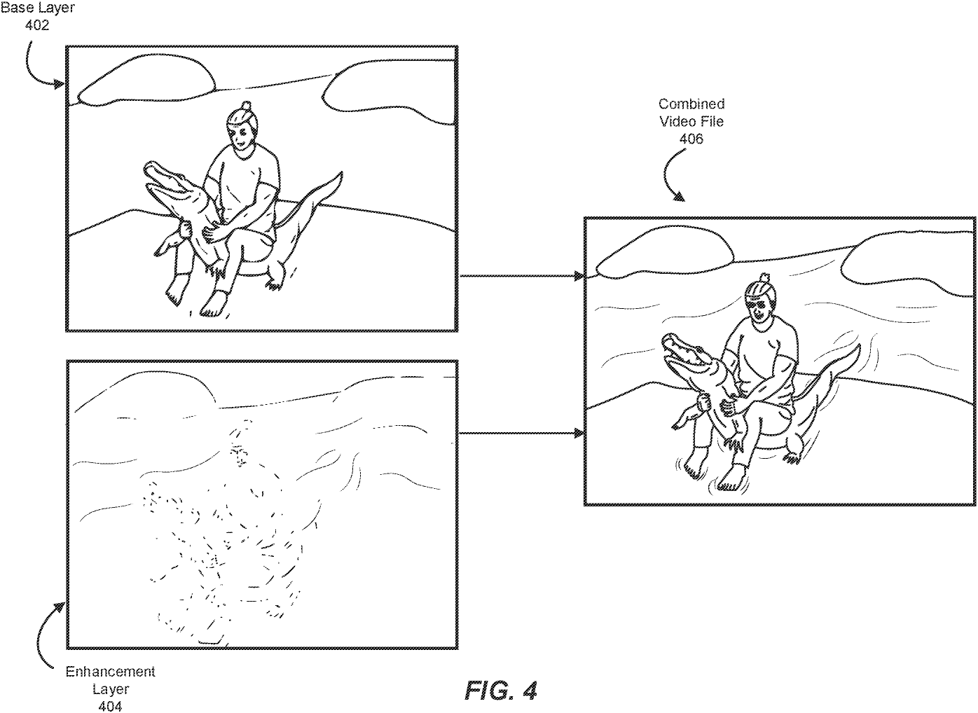

In one embodiment, a decoder may combine a base layer with an enhancement layerto produce a playable video file that is a higher resolution than the base layer. For example, a base layer with a resolution of 540p may be combined with an enhancement layer to arrive at a final resolution of 1080p. In one example, as illustrated in FIG. 4, a video file of a documentary on alligator wrestling may be encoded as a base layer 402 and an enhancement layer 404. In this example, base layer 402 may be a playable and watchable version of the documentary but may be missing or have smoothed-out versions of fine visual details such as the shapes of the alligator’s teeth, strands of hair on the alligator wrestler’s head, the small waves on the river, and the rough edges of the rocks next to the river. Enhancement layer 404 may capture and preserve these visual details, enabling the two layers to be combined to produce a combined video file 406 that is significantly higher resolution than base layer 402.

Encoding module 208 may encode the video file in a variety of ways and/or contexts. For example, encoding module 208 may encode the video file at multiple different resolutions via a single video codec (e.g., H.264). In another example, encoding module 208 may encode the video file via different video codecs (e.g., H.264 and AV1), enabling the video file to be played on a wider variety of client devices. In some examples, encoding module 208 may store a list of resolutions and may produce an encoded version of the video file at each resolution on the list via each different codec. In one example, encoding module 208 may not generate high-resolution base layers via an expensive codec (e.g., computationally expensive in terms of processing power, memory, etc.) but may achieve one or more high-resolution versions of the video file by combining a lower-resolution base layer with an enhancement layer. In some embodiments, encoding module 208 may, for each base layer, compress the video file at a different level of compression that corresponds to the different resolution of the base layer. For example, encoding module 208 may produce a more compressed file with a smaller file size by encoding a video file at a lower resolution.

Returning to FIG. 3, at step 304, one or more of the systems described herein may receive a request for the video file at a specified resolution. For example, receiving module 210 may, as part of server 206 in FIG. 2, receive a request for video file 220 at a specified resolution.

Receiving module 210 may receive the request for the video file in a variety of contexts. For example, receiving module 210 may be part of a streaming media service and may receive a request from a streaming media client to download the video file at the specified resolution. In one example, receiving module 210 may receive a request for the video file from a dedicated media player device such as a smart television. In another example, receiving module 210 may receive the request from a general-purpose computing device such as a laptop or tablet. In some embodiments, receiving module 210 may be part of a social media platform and may receive a request to download and/or stream a video on the social media platform. For example, receiving module 210 may receive a request to transmit a user-uploaded video from the social media platform to a personal computing device.

At step 306, one or more of the systems described herein may provide the video file at the specified resolution by, in response to receiving the request, selecting an appropriate base layer from the plurality of base layers to combine with the enhancement layer to achieve the specified resolution. For example, providing module 212 may, as part of server 206 in FIG. 2, provide video file 220 at the specified resolution by, in response to receiving the request, selecting an appropriate base layer 218 from base layers 216 to combine with enhancement layer 214 to achieve the specified resolution.

Providing module 212 may provide the video file in a variety of ways and/or contexts. For example, providing module 212 may transmit the appropriate base layer and the enhancement layer to the client device, which may decode the base layer and combine the base layer with the enhancement layer to produce a playable version of the video file.

In some embodiments, providing module 212 may provide the base layer and the enhancement layer via different protocols. For example, providing module 212 may transmit the base layer via a reliable protocol such as a transmission control protocol (TCP) but may transmit the enhancement layer via a more scalable yet unreliable protocol such as a user datagram protocol (UDP) and/or multicast UDP. By transmitting the base layer via TCP and the enhancement layer via UDP multicast, the systems described herein may decrease load on a network and/or improve transmission speed and/or efficiency by transmitting the optional enhancement layer via the more efficient but less reliable protocol while ensuring that the crucial base layer is successfully transmitted to the client via a protocol that guarantees the content is viewable even if the enhancement data is occasionally lost.

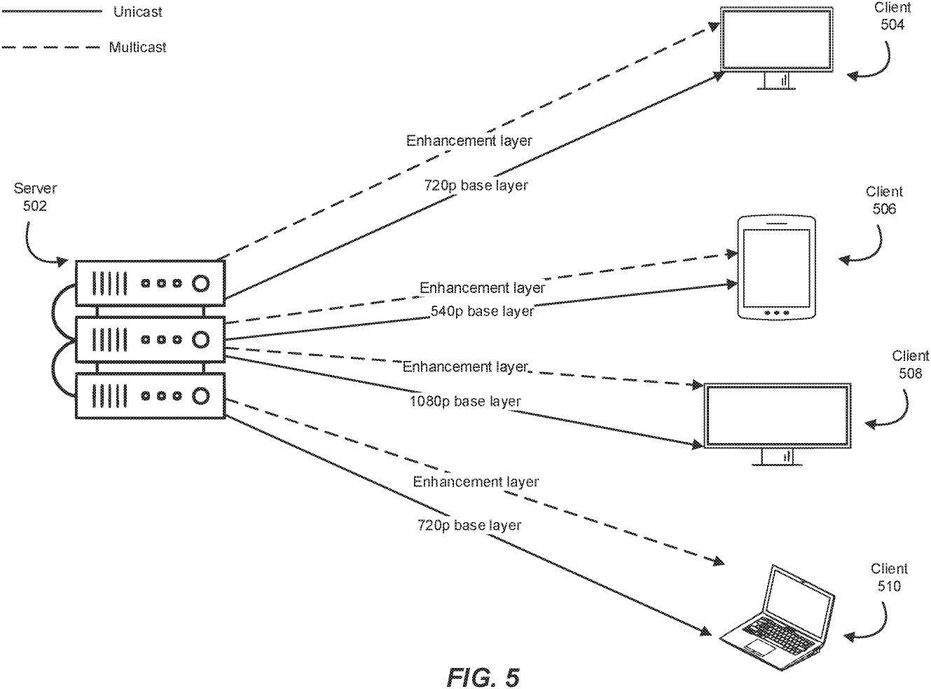

In some embodiments, providing module 212 may provide the video file by multicasting the enhancement layer (e.g., sending the same data packets to multiple clients simultaneously). For example, if multiple clients request the same video file simultaneously (e.g., within a very short time window such as one second, one millisecond, etc.), providing module 212 may unicast a different base layer to each client but may multicast the same enhancement layer to all of the clients. For example, as illustrated in FIG. 5, a server 502 may unicast a 720p base layer to a client 504, a 540p base layer to a client 506, a 1080p base layer to a client 508, and/or a 720p base layer to a client 510. In this example, server 502 may multicast the same enhancement layer simultaneously to each of clients 504, 506, 508, and/or 510. In one embodiment, server 502 may unicast the base layers via TCP while multicasting the enhancement layer via UDP.

In some embodiments, providing module 212 may offer multiple multicast subscriptions for clients. For example, providing module 212 may offer a multicast of a high dynamic range enhancement layer for the video file and a separate multicast of a standard dynamic range version of the enhancement layer for the video file. In some embodiments, these two enhancement layers may share the same base layer.

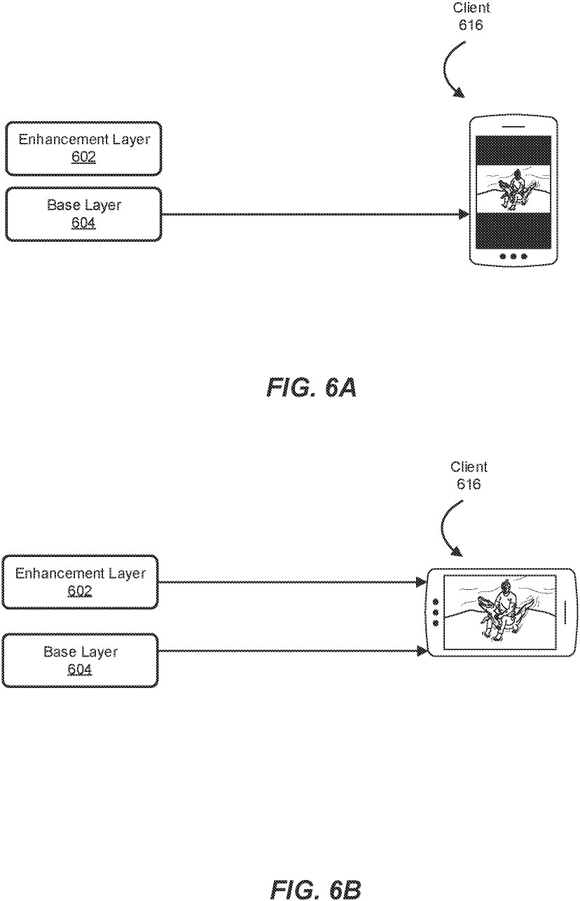

In some embodiments, the systems described herein may enable a client to switch between resolutions on the fly without downloading an unused enhancement layer or re-downloading a redundant base layer. For example, as illustrated in FIG. 6A, a client 616 may be a phone in portrait mode, displaying a video at a very low resolution. In one example, the systems described herein may transmit a base layer 604 to client 616 but may not transmit an enhancement layer 602 due to the low display resolution available. By transmitting only the base layer and not bundling the two layers together, the systems described herein may conserve network resources and/or processing power.

In one example, as illustrated in FIG. 6B, a user may turn client 616 to landscape mode partway through video playback, enlarging the display area of the video and the available pixels to display said video, allowing the video to be presented at a higher resolution. In this example, the systems described herein may enable client 616 to download enhancement layer 602 and apply enhancement layer 602 to base layer 604 to increase the resolution of the video. In some embodiments, client 616 may pre-download and cache segments of the video as soon as video playback begins to avoid buffering. In this example, client 616 may apply enhancement layer 602 to the cached segments of base layer 604 rather than having to discard the cached segments and download an entirely new version of the video that includes the base layer and enhancement layer.

As described above, the systems and methods described herein may improve the efficiency of storing and/or transmitting video files by storing a single copy of an enhancement layer separately from each base layer rather than pre-emptively packaging a copy of the enhancement layer with each base layer. Storing video files in this way may provide systems with additional flexibility in terms of what resolutions to offer as well as conserve computing resources such as memory. In addition, by storing and transmitting base layers and enhancement layers separately, the systems described herein may take advantage of efficiency gains from transmitting enhancement layers via multicasting and/or via lossy protocols.

### Example Embodiments

Example 1: A method for storing and transmitting video files may include (i) encoding a video file at a group of different resolutions by (a) generating a group of base layers for the video file, each at a different resolution within the different resolutions and (b) generating an enhancement layer for the video file that, when combined with any base layer for the video file, increases the effective resolution of a resulting combined video file over a resolution of the base layer, (ii) receiving a request for the video file at a specified resolution, and (iii) providing the video file at the specified resolution by, in response to receiving the request, selecting an appropriate base layer from the base layers to combine with the enhancement layer to achieve the specified resolution.

Example 2: The computer-implemented method of example 1, where generating the base layers may include, for each base layer, compressing the video file at a different level of compression that corresponds to the different resolution of the base layer.

Example 3: The computer-implemented method of examples 1-2, where generating the enhancement layer may include preserving visual details lost from the video file when a compression algorithm is applied to the video file to produce the base layers.

Example 4: The computer-implemented method of examples 1-3, where providing the video file may include transmitting the video file at the specified resolution from a media server that hosts the enhancement layer and the base layers to a client device.

Example 5: The computer-implemented method of examples 1-4, where transmitting the video file at the specified resolution may include transmitting the appropriate base layer and the enhancement layer to be combined on the client device.

Example 6: The computer-implemented method of examples 1-5 may further include (i) receiving a request for the video file at a different specified resolution, (ii) selecting a new appropriate base layer that achieves the different specified resolution when combined with the enhancement layer, (iii) transmitting the new appropriate base layer, and (iv) avoiding re-transmitting the enhancement layer due to having already transmitted the enhancement layer with the appropriate base layer.

Example 7: The computer-implemented method of examples 1-6, where encoding the video file at the different resolutions may include encoding the video file via an encoder of a video codec.

Example 8: A system for storing and transmitting video files may include at least one physical processor and physical memory including computer-executable instructions that, when executed by the physical processor, cause the physical processor to (i) encode a video file at a group of different resolutions by (a) generating a group of base layers for the video file, each at a different resolution within the different resolutions and (b) generating an enhancement layer for the video file that, when combined with any base layer for the video file, increases the effective resolution of a resulting combined video file over a resolution of the base layer, (ii) receive a request for the video file at a specified resolution, and (iii) provide the video file at the specified resolution by, in response to receiving the request, selecting an appropriate base layer from the base layers to combine with the enhancement layer to achieve the specified resolution.

Example 9: The system of example 8, where generating the base layers may include, for each base layer, compressing the video file at a different level of compression that corresponds to the different resolution of the base layer.

Example 10: The system of examples 8-9, where generating the enhancement layer may include preserving visual details lost from the video file when a compression algorithm is applied to the video file to produce the base layers.

Example 11: The system of examples 8-10, where providing the video file may include transmitting the video file at the specified resolution from a media server that hosts the enhancement layer and the base layers to a client device.

Example 12: The system of examples 8-11, where transmitting the video file at the specified resolution may include transmitting the appropriate base layer and the enhancement layer to be combined on the client device.

Example 13: The system of examples 8-12, where the computer-executable instructions cause the physical processor to (i) receive a request for the video file at a different specified resolution, (ii) select a new appropriate base layer that achieves the different specified resolution when combined with the enhancement layer, (iii) transmit the new appropriate base layer, and (iv) avoid re-transmitting the enhancement layer due to having already transmitted the enhancement layer with the appropriate base layer.

Example 14: The system of examples 8-13, where encoding the video file at the different resolutions may include encoding the video file via an encoder of a video codec.

Example 15: A non-transitory computer-readable medium may include one or more computer-readable instructions that, when executed by at least one processor of a computing device, cause the computing device to (i) encode a video file at a group of different resolutions by (a) generating a group of base layers for the video file, each at a different resolution within the different resolutions and (b) generating an enhancement layer for the video file that, when combined with any base layer for the video file, increases the effective resolution of a resulting combined video file over a resolution of the base layer, (ii) receive a request for the video file at a specified resolution, and (iii) provide the video file at the specified resolution by, in response to receiving the request, selecting an appropriate base layer from the base layers to combine with the enhancement layer to achieve the specified resolution.

Example 16: The computer-readable medium of examples 14-15, where generating the base layers may include, for each base layer, compressing the video file at a different level of compression that corresponds to the different resolution of the base layer.

Example 17: The computer-readable medium of examples 14-16, where generating the enhancement layer may include preserving visual details lost from the video file when a compression algorithm is applied to the video file to produce the base layers.

Example 18: The computer-readable medium of examples 14-17, where providing the video file may include transmitting the video file at the specified resolution from a media server that hosts the enhancement layer and the base layers to a client device.

Example 19: The computer-readable medium of examples 14-18, where transmitting the video file at the specified resolution may include transmitting the appropriate base layer and the enhancement layer to be combined on the client device.

Example 20: The computer-readable medium of examples 14-18, where the computer-readable instructions cause the processor to (i) receive a request for the video file at a different specified resolution, (ii) select a new appropriate base layer that achieves the different specified resolution when combined with the enhancement layer, (iii) transmit the new appropriate base layer, and (iv) avoid re-transmitting the enhancement layer due to having already transmitted the enhancement layer with the appropriate base layer.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
encoding a video file at a plurality of different resolutions by:
generating a plurality of base layers for the video file, each at a different resolution within the plurality of different resolutions; and
generating an enhancement layer for the video file that, when combined with any base layer for the video file, increases an effective resolution of a resulting combined video file over a resolution of the base layer;
receiving a request for the video file at a specified resolution; and
providing the video file at the specified resolution by, in response to receiving the request, selecting an appropriate base layer from the plurality of base layers to combine with the enhancement layer to achieve the specified resolution.

2. The computer-implemented method of claim 1, wherein generating the plurality of base layers comprises, for each base layer, compressing the video file at a different level of compression that corresponds to the different resolution of the base layer.

3. The computer-implemented method of claim 1, wherein generating the enhancement layer comprises preserving visual details lost from the video file when a compression algorithm is applied to the video file to produce the plurality of base layers.

4. The computer-implemented method of claim 1, wherein providing the video file comprises transmitting the video file at the specified resolution from a media server that hosts the enhancement layer and the plurality of base layers to a client device.

5. The computer-implemented method of claim 4, wherein transmitting the video file at the specified resolution comprises transmitting the appropriate base layer and the enhancement layer to be combined on the client device.

6. The computer-implemented method of claim 1, further comprising:
receiving a request for the video file at a different specified resolution;
selecting a new appropriate base layer that achieves the different specified resolution when combined with the enhancement layer;
transmitting the new appropriate base layer; and
avoiding re-transmitting the enhancement layer due to having already transmitted the enhancement layer with the appropriate base layer.

7. The computer-implemented method of claim 1, wherein encoding the video file at the plurality of different resolutions comprises encoding the video file via an encoder of a video codec.

8. A system comprising:
at least one physical processor; and
physical memory comprising computer-executable instructions that, when executed by the physical processor, cause the physical processor to:
encode a video file at a plurality of different resolutions by:
generating a plurality of base layers for the video file, each at a different resolution within the plurality of different resolutions; and
generating an enhancement layer for the video file that, when combined with any base layer for the video file, increases an effective resolution of a resulting combined video file over a resolution of the base layer;
receive a request for the video file at a specified resolution; and
provide the video file at the specified resolution by, in response to receiving the request, selecting an appropriate base layer from the plurality of base layers to combine with the enhancement layer to achieve the specified resolution.

9. The system of claim 8, wherein generating the plurality of base layers comprises, for each base layer, compressing the video file at a different level of compression that corresponds to the different resolution of the base layer.

10. The system of claim 8, wherein generating the enhancement layer comprises preserving visual details lost from the video file when a compression algorithm is applied to the video file to produce the plurality of base layers.

11. The system of claim 8, wherein providing the video file comprises transmitting the video file at the specified resolution from a media server that hosts the enhancement layer and the plurality of base layers to a client device.

12. The system of claim 11, wherein transmitting the video file at the specified resolution comprises transmitting the appropriate base layer and the enhancement layer to be combined on the client device.

13. The system of claim 8, wherein the computer-executable instructions cause the physical processor to:
receive a request for the video file at a different specified resolution;
select a new appropriate base layer that achieves the different specified resolution when combined with the enhancement layer;
transmit the new appropriate base layer; and
avoid re-transmitting the enhancement layer due to having already transmitted the enhancement layer with the appropriate base layer.

14. The system of claim 8, wherein encoding the video file at the plurality of different resolutions comprises encoding the video file via an encoder of a video codec.

15. A non-transitory computer-readable medium comprising one or more computer-readable instructions that, when executed by at least one processor of a computing device, cause the computing device to:
encode a video file at a plurality of different resolutions by:
generating a plurality of base layers for the video file, each at a different resolution within the plurality of different resolutions; and
generating an enhancement layer for the video file that, when combined with any base layer for the video file, increases an effective resolution of a resulting combined video file over a resolution of the base layer;
receive a request for the video file at a specified resolution; and
provide the video file at the specified resolution by, in response to receiving the request, selecting an appropriate base layer from the plurality of base layers to combine with the enhancement layer to achieve the specified resolution.

16. The computer-readable medium of claim 15, wherein generating the plurality of base layers comprises, for each base layer, compressing the video file at a different level of compression that corresponds to the different resolution of the base layer.

17. The computer-readable medium of claim 15, wherein generating the enhancement layer comprises preserving visual details lost from the video file when a compression algorithm is applied to the video file to produce the plurality of base layers.

18. The computer-readable medium of claim 15, wherein providing the video file comprises transmitting the video file at the specified resolution from a media server that hosts the enhancement layer and the plurality of base layers to a client device.

19. The computer-readable medium of claim 18, wherein transmitting the video file at the specified resolution comprises transmitting the appropriate base layer and the enhancement layer to be combined on the client device.

20. The computer-readable medium of claim 15, wherein the computer-readable instructions cause the processor to:
receive a request for the video file at a different specified resolution;
select a new appropriate base layer that achieves the different specified resolution when combined with the enhancement layer;
transmit the new appropriate base layer; and
avoid re-transmitting the enhancement layer due to having already transmitted the enhancement layer with the appropriate base layer.
